(19) United States
(12) Patent Application Publication
(10) Pub. No.: US 2015/0013614 A1
(43) Pub. Date: Jan. 15, 2015

(54) Transport Container For Animals Having A Coat

(71) Applicant: Karl SALZMANN, Ginsheim (DE)

(72) Inventor: Karl SALZMANN, Ginsheim (DE)

(21) Appl. No.: 14/038,887

(22) Filed: Sep. 27, 2013

(30) Foreign Application Priority Data
Jul. 14, 2013 (DE) DE102013107441.3

(51) Int. Cl. A01K 1/02; A01K 1/00

(52) U.S. Cl. CPC A01K 1/0272; A01K 1/0035
USPC 119/453; 119/496

(57) ABSTRACT

A transport container, configured to be mountable in a vehicle, for animals having a coat, has two side walls 1, 1′, a front wall 2 and a cover wall 3. The walls are at least partially composed of a flexible netting material. The flexible netting material has a mesh width<1.5 mm.

### BACKGROUND OF THE INVENTION

1. Field of the Invention

The invention relates to a transport container, configured to be mountable in a vehicle, for transporting animals having a coat, the transport container having two side walls, a front wall and a cover wall, the walls being at least partially composed of a flexible netting material.

2. Description of the Related Art

In the case of known animal transport containers, the netting material is wide-meshed since it serves only as a separation of the interior of the transport container from the further interior of the vehicle and is intended to prevent an animal, for example a dog, from entering the further interior of the vehicle.

### SUMMARY OF THE INVENTION

It is the object of the invention to provide a transport container for animals having a coat, the transport container avoiding an adverse effect on the further interior of the vehicle, and on people present therein, due to hairs from the coat of the animal.

This object is achieved, according to an aspect of the invention, in that the flexible netting material has a mesh width<1.5 mm.

By using the transport container according to an aspect of the present invention, hairs from the coat lost by an animal, for example a dog, cannot pass through the walls of the transport container from the interior thereof to the outside into the further interior of the vehicle, due to the small mesh width.

This avoids a generally difficult removal of the animal hairs from the further interior of the vehicle. This also avoids health-problem-inducing inhalation of animal hairs by people in the further interior of the vehicle. Further, because the further interior of the vehicle is kept free from animal hairs, it is avoided that, in particular, animal hairs get into the vehicle driver's eye where they can lead to tears and therefore to a traffic-endangering situation. Animal hairs can also clog the filter of the air-conditioning system, can contaminate the clothing of vehicle occupants, can be an odor nuisance, can cause allergies in allergic people and can disseminate unpleasant odors. All of these problems are at least substantially avoided by the transport container according to an aspect of the invention.

The adverse effect due to animal hairs is particularly effectively avoided if the flexible netting material has a mesh width<1.0 mm, in particular a mesh width of between 0.04 and 0.5 mm.

If the netting material is transparent, then, when the transport container is arranged in a boot of the vehicle, the driver of the vehicle can readily observe the region behind the vehicle through the rear window.

At the same time, it is calming for the animal transported in the transport container to be able readily to see its surroundings.

In an aspect of the present invention, at least the front wall can be at least partially composed of the flexible netting material.

In another aspect, the interior of the transport container is completely closed if the animal transport container has a floor.

This makes it possible, for cleaning the transport container, to completely remove the latter from the vehicle.

For adaptation to the floor of the vehicle, the floor of the transport container can also be composed of a flexible material and can be composed of a water-impermeable material to protect against the passage of fluids.

However, it is also possible for the floor and also the walls to be composed of the flexible netting material and for a floor mat to be placed on to the floor in the transport container. The floor mat can then be composed of a water-impermeable material to protect against the passage of fluids.

In another aspect, the flexible netting material and/or the floor are/is preferably composed here of a durable and easily cleanable material, such as, for example, of a polyamide.

If the transport container is arrangeable in a vehicle boot having a rear opening, then a separate closure is not required for the rear-side opening of the transport container. The rear-side opening of the transport container is then closable by the tailgate.

The transport container here, on the side opposite the front wall, can have an opening at least approximately corresponding to the rear opening of the vehicle, and the borders of the side walls and of the cover wall, and optionally of the floor, can be fastenable along the opening to the opening border of the rear opening that is closable by the tailgate.

When the size of the rear opening of the vehicle and opening of the transport container do not correspond, the transport container, on the side opposite the front wall, can have an opening, and the borders of the side walls and of the cover wall, and optionally of the floor, can be fastenable along the opening via a tubular, flexible intermediate part to the opening border of the rear opening that is closable by the tailgate.

The intermediate part in this case has the function of an adapter.

In both variant embodiments, there is an absolute separation between the interior of the transport container and the further interior of the vehicle irrespective of whether the tailgate is opened or closed.

In a simple embodiment here, a tailgate seal, which is preferably already present on the vehicle, can be arranged on the opening border of the rear opening, and the borders of the side walls and of the cover wall, and optionally of the floor, or the peripheral border of the intermediate part, which border faces away from the transport container, can be connectable to the tailgate seal or to a carrier part of the seal.

If the tailgate seal is a sealing beading which can be slipped on to a web extending along the rear opening, wherein the borders of the side walls and of the cover wall and optionally of the floor, or the peripheral border of the intermediate part, are/is arranged on the web and overlapped by the sealing beading, no additional components are required for fastening the borders of the transport container.

An easy connection of the borders of the transport container to the tailgate seal is also possible if the tailgate seal is a U-shaped sealing beading that can be slipped on to a web extending along the rear opening, wherein the borders of the side walls and of the cover wall and optionally of the floor, or the peripheral border of the intermediate part, are/is connectable to that limb of the “U” of the sealing beading that is closer to the rear opening.

For this purpose, in a simple manner not requiring any installation tools, a touch-and-close-like strip is fixedly arranged on that limb of the “U” of the sealing beading that is closer to the rear opening, and the borders of the side walls and of the cover wall and optionally of the floor, or the peripheral border of the intermediate part, are/is releasably connectable to the touch-and-close-like strip.

Manufacturing can be simple if the side walls, front wall and cover wall, and optionally the intermediate part, are separate components that are connected to one another at their mutually adjacent borders by welding and/or sewing.

However, it is also possible for the side walls, cover wall and floor to be produced as a single-part, tubular component, the one opening side of which is then closed by the front wall.

In order to fix the transport container in the boot of the vehicle, the transport container can be releasably fastenable to wall regions and/or to the boot floor of the boot of the vehicle.

For this purpose, fastening eyes can be arranged along the connecting regions of the side walls to the front wall and to the cover wall, the fastening eyes being connectable by connecting elements to holding elements on wall regions and/or on the boot floor of the boot of the vehicle.

If the connecting elements here are elastic tension elements, then the connecting elements can be used even in the event of different distances between the fastening eyes and the holding elements.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the invention are illustrated in the drawings and are described in more detail below. In the drawings:

FIG. 1 is a perspective view of a transport container in accordance with an embodiment of the present invention;

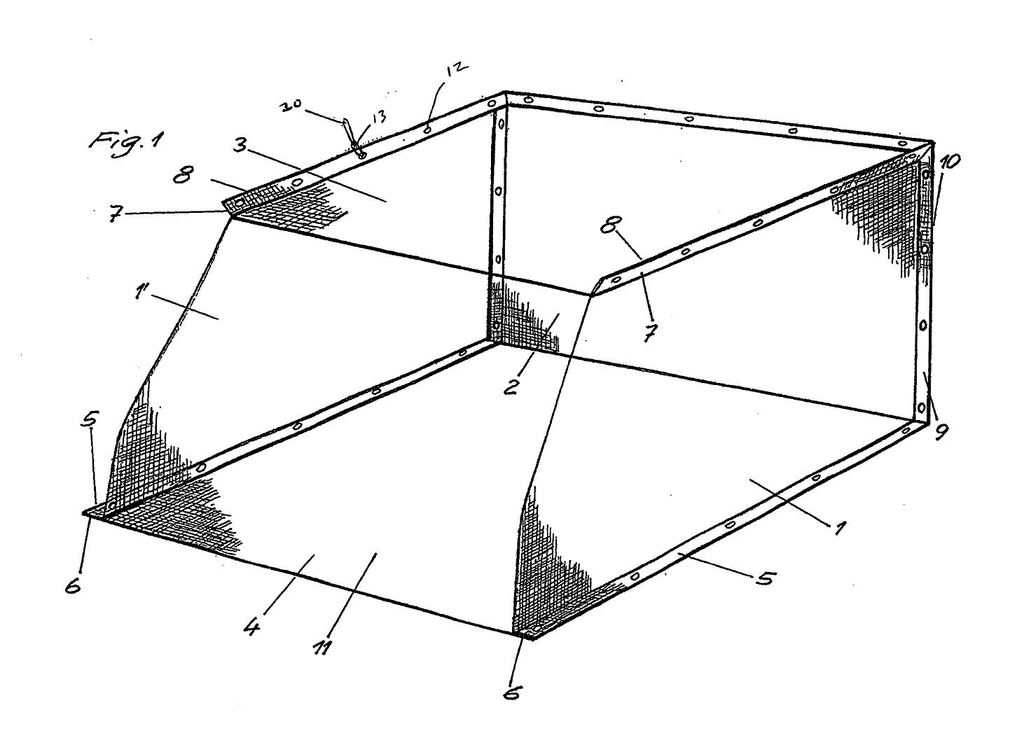

FIG. 2 is a perspective exploded illustration of a section of a sealing beading and of a section of a web with overlapping flexible netting material;

FIG. 3 is a perspective illustration of a section of a sealing beading with a touch-and-close-like strip and flexible netting material arranged thereon; and

FIG. 4 is a perspective illustration of a corner region of the transport container according to FIG. 1.

### DETAILED DESCRIPTION OF THE PRESENTLY PREFERRED EMBODIMENTS

The transport container illustrated in the figures has two identical side walls 1, 1′, a front wall 2, a cover wall 3 and a floor 4. All of the walls 1 to 3 and the floor 4 are composed of a flexible netting material made from a polyamide and having a mesh width<1.5 mm.

The side walls 1, 1′, along their lower edge region 5, and the front wall 2, overlap edge regions 6 of the floor 4. The mutually overlapping edge regions 5, 6 are connected to one another by welding.

In the same manner, the upper edge regions 7 of the side walls 1, 1′ and the front wall 2 overlap the edge regions 8 of the cover wall and the vertical edge regions 9 of the side walls 1, 1′ and the vertical edge regions 10 of the front wall 2 and are welded to one another.

As a result, the transport container is closed, apart from on the rear side thereof, at which the transport container has an opening 11.

The transport container is preferably produced approximately in a shape and size that corresponds to the shape and size of a vehicle boot having a rear opening.

Eyes 12 are provided to which elastic tension elements 13, such as rubber loops, are connected. The elastic tension elements 13 are releasably connectable to holding elements 20 on wall regions and on the boot floor of the vehicle, and are formed at regular distances in the outwardly exposed, mutually overlapping edge regions.

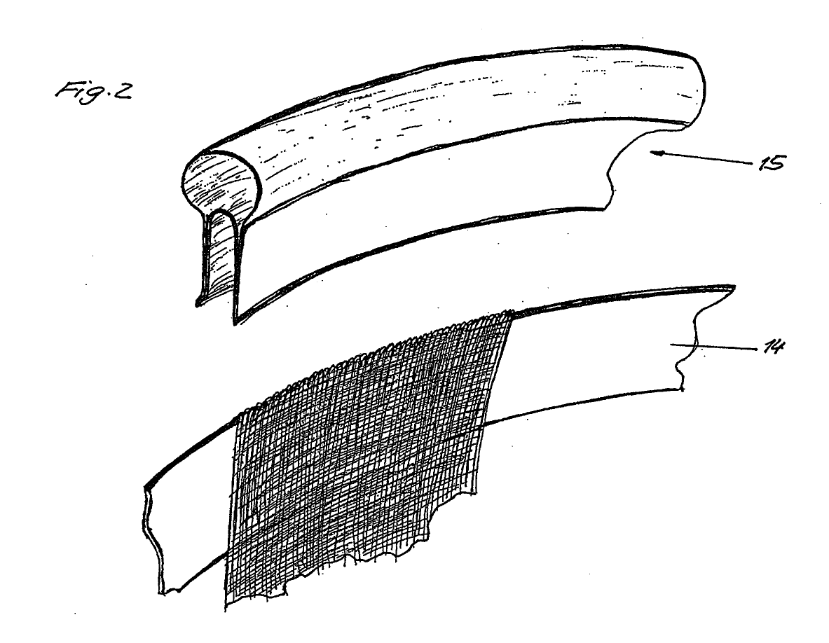

As can be seen in FIG. 2, a web 14, onto which a sealing beading 15 that is U-shaped in cross section has been slipped, extends along the opening border of the rear opening of the boot of the vehicle (not illustrated).

When the rear opening is closed by a tailgate, the peripheral border of the tailgate rests on the sealing beading 15.

FIG. 2 shows the sealing beading 15 and web 14 in an exploded illustration. The border region overlaps the web 14 along the opening 11 of the flexible netting material, for example of the side wall 1. If the sealing beading 15 is then slipped onto the web 14, the border region of the transport container is fixedly connected along the opening 11 thereof to the opening border of the rear opening of the boot. The interior of the transport container, in which an animal, for example a dog, is transported, has no connection to the boot of the vehicle other than by the flexible netting material, irrespective of whether the tailgate is closed or open.

The tailgate in this case is, at the same time, also the closure of the transport container.

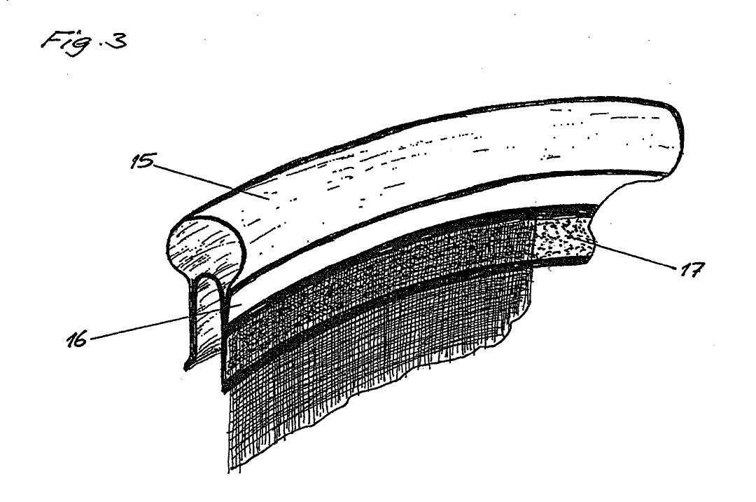

FIG. 3 shows an alternative to the embodiment according to FIG. 2, in which the arrangement of web 14 and sealing beading corresponds to the embodiment according to FIG. 2. A touch-and-close-like strip 17 is fixedly arranged on the limb 16 of the “U” of the sealing beading 15 that faces the interior region of the rear opening, and the border region of the transport container is fixedly connected along the opening 11 thereof to the opening border of the rear opening of the boot at the touch-and-close-like strip.

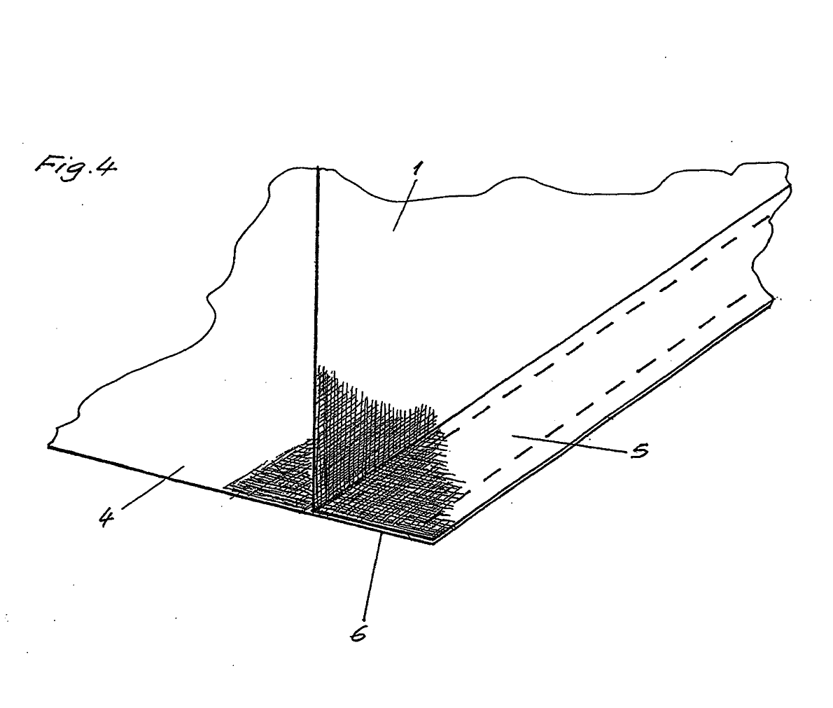

FIG. 4 shows, in enlarged form, the overlapping edge regions 5 and 6 of the side wall 1 and floor 4 in the region of the opening 11 of the transport container

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A transport container, configured to be mountable in a vehicle, for transporting animals having a coat, the transport container comprising:
two side walls (1, 1′);
a front wall (2); and
a cover wall (3), said side walls, front wall and cover wall each being at least partially composed of a flexible netting material, wherein the flexible netting material has a mesh width of <1.5 mm.

2. The transport container according to claim 1, wherein the flexible netting material has a mesh width of <1.0 mm.

3. The transport container according to claim 1, wherein the flexible netting material has a mesh width of between 0.04 and 0.5 mm.

4. The transport container according to claim 1, wherein at least the front wall (2) is at least partially composed of the flexible netting material.

5. The transport container according to claim 1, wherein the flexible netting material is transparent.

6. The transport container according to claim 1, wherein the transport container further comprises a floor (4).

7. The transport container according to claim 6, wherein the floor (4) is composed of a flexible material.

8. The transport container according to claim 6, wherein the floor is composed of a water-impermeable material.

9. The transport container according to claim 6, wherein the flexible netting material and/or the floor (4) are/is composed of a polyamide.

10. The transport container according to claim 6, wherein the transport container is arrangeable in a vehicle boot that has a rear opening that is closable by a tailgate.

11. The transport container according to claim 10, wherein the transport container, on a side opposite the front wall (2), has an opening (11) at least substantially corresponding to the rear opening of the vehicle boot, and borders of the side walls (1, 1′) and of the cover wall (3), and optionally of the floor (4), are fastenable along the opening (11) to an opening border of the rear opening that is closable by the tailgate.

12. The transport container according to claim 10, wherein the transport container, on a side opposite the front wall, has an opening, and borders of the side walls and of the cover wall, and optionally of the floor, are fastenable along the opening via a tubular, flexible intermediate part to an opening border of the rear opening that is closable by the tailgate.

13. The transport container according to claim 12, wherein a tailgate seal is arranged on the opening border of the rear opening, and the borders of the side walls (1, 1′) and of the cover wall (3), and optionally of the floor (4), or a peripheral border of the intermediate part, which border faces away from the transport container, are/is connectable to the tailgate seal or to a carrier part of the tailgate seal.

14. The transport container according to claim 13, wherein the tailgate seal is a sealing beading (15) which can be slipped onto a web (14) extending along the rear opening, wherein the borders of the side walls (1, 1′) and of the cover wall (3), and optionally of the floor (4), or the peripheral border of the intermediate part, are/is arranged on the web and overlapped by the sealing beading.

15. The transport container according to claim 13, wherein the tailgate seal is a U shaped sealing beading (15) which can be slipped on to a web (14) extending along the rear opening, wherein the borders of the side walls (1, 1′) and of the cover wall (3), and optionally of the floor (4), or the peripheral border of the intermediate part, are/is connectable to a limb (16) of the “U” of the sealing beading (15) that is closer to the rear opening.

16. The transport container according to claim 15, wherein a touch-and-close-like strip (17) is fixedly arranged on the limb (16) of the “U” of the sealing beading (15) that is closer to the rear opening, and the borders of the side walls (1, 1′) and of the cover wall (3), and optionally of the floor (4), or the peripheral border of the intermediate part, are/is releasably connectable to said touch-and-close-like strip.

17. The transport container according to claim 12, wherein the side walls (1, 1′), front wall (2), cover wall (3) and floor (4), and optionally the intermediate part, are separate components which are connected to one another at mutually adjacent borders by welding and/or sewing.

18. The transport container according to claim 10, wherein the transport container is releasably fastenable to wall regions of the vehicle boot and/or to a floor of the vehicle boot.

19. The transport container according to claim 18, further comprising fastening eyes (12) arranged along connecting regions of the side walls (1, 1′), the front wall (2) and the cover wall (3), said fastening eyes being connectable by connecting elements to holding elements on the wall regions of the vehicle boot and/or on the floor of the boot.

20. The transport container according to claim 19, wherein the connecting elements are elastic tension elements (13).
